(19) United States
(12) Patent Application Publication
(10) Pub. No.: US 2004/0178095 A1
(43) Pub. Date: Sep. 16, 2004

(54) Multi-functional golf accessory

(76) Inventors: Robert E. Mora, Worthington, OH (US); Ludwin M. Mora, Worthington, OH (US); Todd J. Ohler, Columbus, OH (US); Courtney J. Miller, Columbus, OH (US)

Correspondence Address: Courtney J. Miller, 2158 Northam Rd., Columbus, OH, 43221, US

(21) Appl. No.: 10/800,045

(22) Filed: Mar. 12, 2004

Related U.S. Application Data
(60) Provisional application No. 60/454,961, filed on Mar. 14, 2003.

(51) Int. Cl. A45F 5/00; B25B 5/00; B65D 85/00

(52) U.S. Cl. 206/315.9

(57) ABSTRACT

A multi-functional golf accessory for storing a variety of golf related tools and items. The accessory includes a base component that is adapted to receive a detachable caddy device and that provides external and internal storage space. The caddy mounts in the base and further includes a body adapted to receive a divot repair device that holds a ball marker, a detachable belt clip, at least one golf tee, and a golf ball or a stroke counting device. The stroke counting device is adapted to be mountable in the caddy device, is substantially spherical in shape, and has substantially the same dimensions as a golf ball. The base includes a front portion having additional storage space for golf balls and tees, and a rear portion having a smooth exterior writing surface, a clip means for holding a score card and a golf pencil, and internal storage compartments.

### CROSS-REFERENCE TO RELATED APPLICATIONS

This patent application claims the benefit of U.S. Provisional Patent Application Serial No. 60/454,961 filed on Mar. 14, 2003 and entitled “Golf Accessory,” the disclosure of which is incorporated as if fully rewritten herein.

### STATEMENT REGARDING FEDERALLY FUNDED RESEARCH

This invention was not made by an agency of the United States Government nor under contract with any agency of the United States Government.

### TECHNICAL FIELD OF THE INVENTION

The present invention relates generally to sporting or recreational goods, and more specifically to a portable, multi-functional accessory for the game of golf.

### BACKGROUND OF THE INVENTION

The game of golf typically requires the golfer to carry or otherwise transport certain equipment, i.e., clubs, as well as numerous accessories such as golf balls, tees, ball markers, gloves, divot repair devices, score cards, etc. Because the average golfer often finds himself or herself some distance away from his or her bag or golf cart during a round of golf, quick access to certain desired accessories may be difficult. Furthermore, additional balls and tees are often buried or hidden in the various storage areas of golf bag and may be difficult to locate. Thus, it is not uncommon for game of golf to be delayed by lost balls, broken tees, or players hitting another player's ball by mistake. Some or all of these problems could be reduced or even eliminated if the golfer was able to utilize a small, portable accessory that would provide access to items such as additional balls, tees, ball markers, and the like, and that would allow a golfer to easily personalize their golf balls.

Accessories for the golfer are commonplace and are widely available at sporting goods or other specialty stores. However, many of the currently available golf accessories are poorly designed, cheaply constructed, uncomfortable or unwieldy, not terribly useful, or simply unattractive. All of these typical shortcomings result in an accessory that may be purchased, but that is seldom used; or if it is used, it proves to be only marginally effective for its intended purpose. Thus, there is a need for an, attractive, highly functional, multi-purpose storage device that the golfer will actually use each time a round of golf is played.

### SUMMARY OF THE INVENTION

These and other disadvantages of the prior art are overcome by the present invention, the exemplary embodiment of which provides a multi-functional, highly adaptable, golf accessory that is designed to store a variety of golf related tools and items. This multi-functional golf accessory includes a base component that is adapted to receive a detachable caddy device and to provide external and internal storage space. The caddy device is adapted to receive a detachable stroke counting device.

The caddy device is adapted to be detachably mounted in the base and further includes a frame or body that is adapted to receive: (i) a divot repair device that holds a ball marker, (ii) a detachable clip, (iii) at least one golf tee, and (iv) a golf ball or a stroke counting device. The body of the caddy device also includes a stencil or template for making unique markings on a golf ball. The slim profile of the caddy device keeps it out of the way of the golfer's swing so the device may be worn on the player's belt throughout the round. The stroke counting device is adapted to be mountable in the caddy device, is substantially spherical in shape, and has substantially the same dimensions as a standard golf ball. The stroke counting device utilizes mechanical, electronic, or digital means for counting the strokes and may include clock, compass, and calculator functionality.

The exemplary embodiment of the base component includes a front portion that further includes two cups for storing additional golf balls and plurality of apertures for storing additional golf tees, and a rear portion joined to the front portion by a hinge. The rear portion includes a smooth exterior surface for providing a writing surface, a first clip means for holding a golf score card or other paper, a second clip means for holding a golf pencil, and two storage compartments formed on the interior of the rear portion of the base.

Further advantages of the present invention will become apparent to those of ordinary skill in the art upon reading and understanding the following detailed description of the preferred embodiments.

### BRIEF DESCRIPTION OF THE DRAWINGS

The accompanying drawings, which are incorporated into and form a part of the specification, schematically illustrate an exemplary embodiment of the invention and, together with the general description given above and detailed description of the preferred embodiments given below, serve to explain the principles of the invention.

FIG. 1 is a perspective view of the assembled multi-functional golf accessory of the present invention showing the caddy device, the stroke counting device, and the base.

FIG. 2 is an exploded perspective view of the device of FIG. 1 showing the arrangement of the various components and work-pieces relative to one another.

FIG. 3 is an exploded front perspective view of the caddy device showing the arrangement of the various components and work-pieces relative to one another.

FIG. 4 is a front view of the assembled caddy device showing the stenciling template formed in the cup.

FIG. 5 is perspective rear view of the assembled caddy device showing the stenciling template and the detachable belt clip.

FIG. 6a is a front perspective view of the assembled caddy device showing the stroke counting device mounted in the cup rather than a golf ball.

FIG. 6b is a top view of the caddy device showing the assembled caddy device with the stroke counting device mounted in the cup rather than a golf ball and showing the proper positioning of the stroke counter so that the golfer may see the display area when wearing the caddy device on his or her belt.

FIG. 7a is a top view of the stroke counting device.

FIG. 7b is a bottom view of the stroke counting device.

FIG. 7c is a side view of the stroke counting device.

FIG. 8a is a front view of the base component of the multi-functional golf accessory of FIG. 1 showing the front portion of the base, the port for the caddy device, and the additional cups for storing golf balls.

FIG. 8b is a rear perspective view of the base component showing the writing surface, the clips for holding a score card, and the clips for holding a pencil or other writing instrument.

FIG. 9 is a front perspective view of the interior of the base component showing the front and rear portions of the base as well as the various internal storage trays and the closing panel.

FIG. 10a is a top view of the base component of the multi-functional golf accessory of FIG. 1.

FIG. 10b is a side view of the base component showing the apertures formed in the front portion for storing tees and the clips formed in the rear portion for holding a golf pencil.

### DETAILED DESCRIPTION OF THE INVENTION

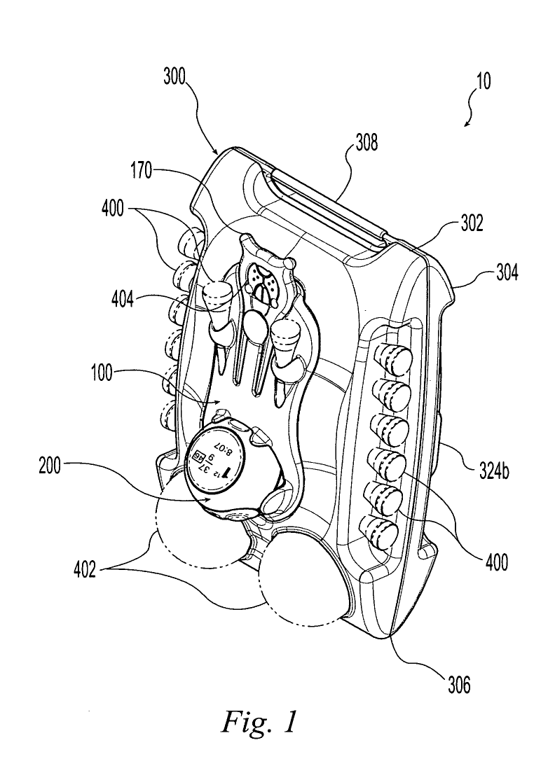

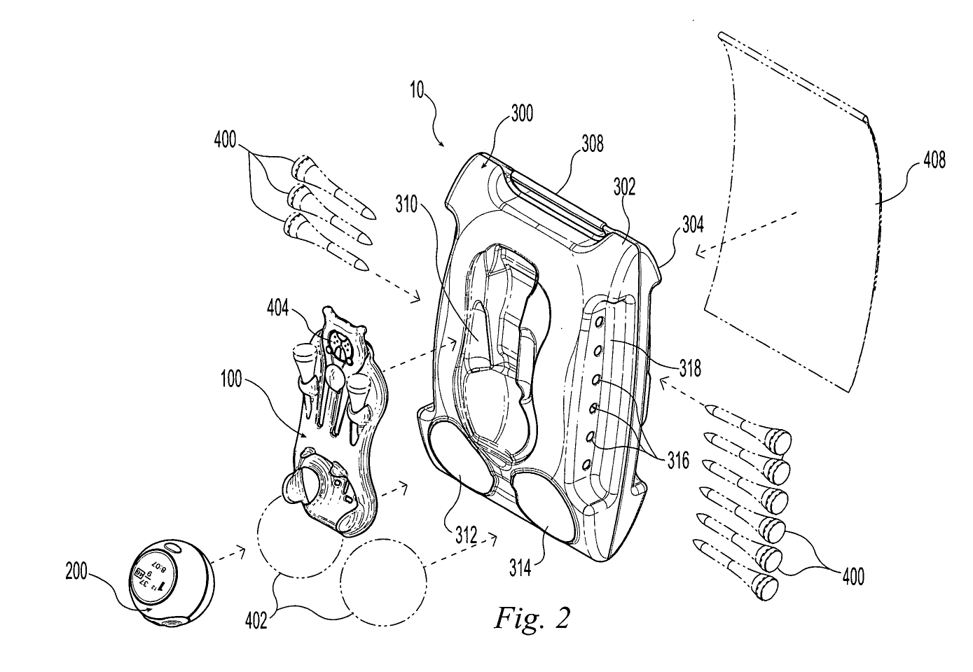

With reference now to the Figures, and to FIGS. 1 and 2 in particular, an exemplary embodiment of the present invention provides a multi-functional golf accessory 10 that includes a portable caddy device 100 that is adapted to receive and hold a golf-ball shaped stroke counting device 200, and a “docking station” or base 300 that is adapted to receive and hold the caddy device. Typically, the user of golf accessory 10 will attach the assembled accessory to a golf bag, remove the detachable caddy from the base, and clip the caddy to his or her belt prior to or while playing a round of golf.

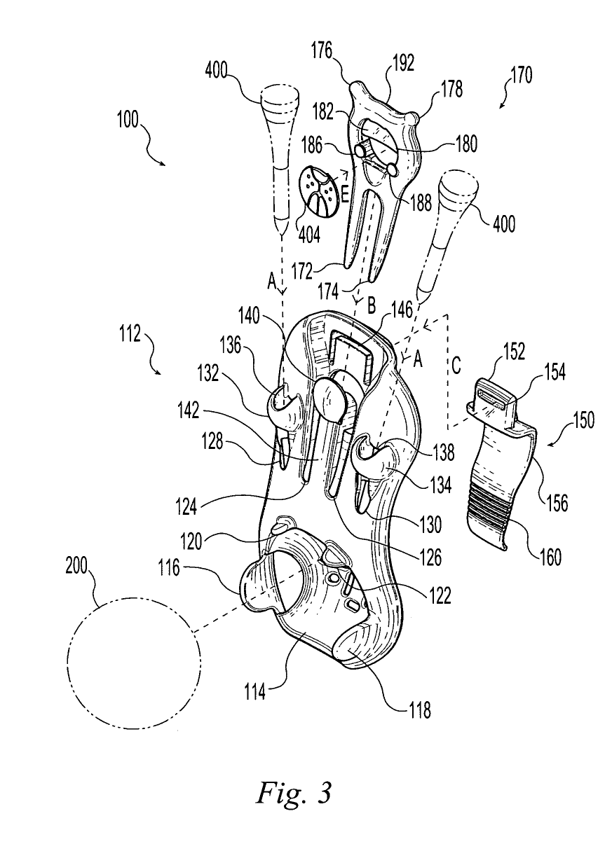

As best shown in FIGS. 3-5, an exemplary embodiment of detachable caddy device 100 includes a body 112 that is adapted to receive a divot repair device 170, a detachable belt clip 150, two golf tees 400, and either a golf ball 402 or stroke counting device 200. The divot repair device is a tool or implement that may be used to repair divots left on the green or elsewhere; it may also serve as a club prop and as a frame for holding a ball marker. With reference to FIG. 3, the lower portion of body 112 comprises a cup 114 into which golf ball 402 or stroke counting device 200 may be inserted and secured. Cup 114 further comprises a first side clasp 116 and a second side clasp 118, as well as a first top clasp 120 and a second top clasp 122. The user of the caddy device simply snaps a golf ball into cup 114 (see arrow “D” in FIG. 3) and the various clasps serve to secure the ball in place while still allowing the user to easily remove the ball when desired. In an alternate embodiment (not shown), body 112 has been modified to include multiple cups 114, which are located either side-by-side or one on top of the other, for holding additional golf balls.

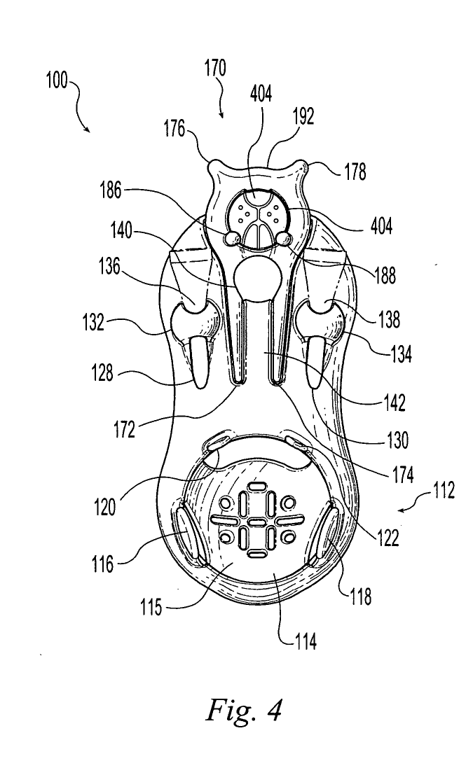

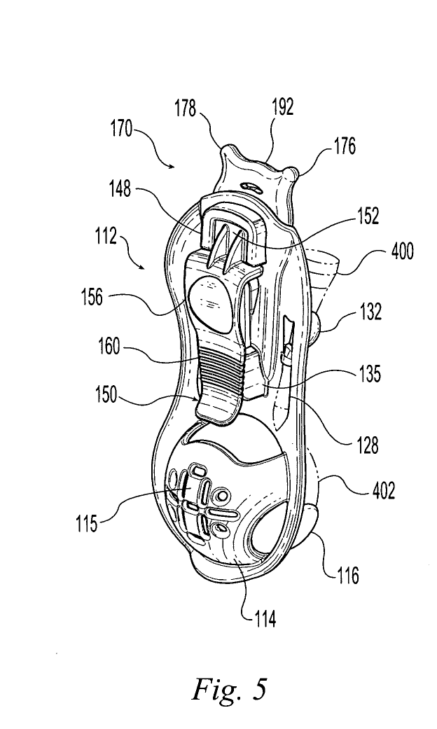

As best shown in FIGS. 4 and 5, cup 114 also includes a template 115 that may be used by a golfer to create a unique pattern on his or her golf ball for the purpose of accurately identifying the ball. The pattern may also be used for putting alignment. The user places golf ball 402 into cup 114, turns the caddy device over and while holding the ball with one hand, uses the other hand to stencil a number, letter, or other pattern on the surface of the ball. A common magic marker or felt tip pen is suitable for this task.

With reference to FIGS. 3-5, the middle and upper portions of body 112 comprise a first group of structural features for holding divot repair device 170 and second group of structural features for holding the golf tees. Viewing caddy device 100 from the front, first body groove 124 is formed on the left front side of body 112 and second body groove 126 is formed on the right front side of body 112. In the exemplary embodiment, these two grooves are tapered at the bottom and gradually expand upward to a point where they join and form a single groove that extends to the topmost portion of body 112. This single groove forms seat 144, and together with the two body grooves forms the portion of body 112 that accepts divot repair device 170 (see arrow “B” in FIG. 3). The area between body grooves 124 and 126 includes tongue 142 and button 140. In addition to providing a surface area upon which a company logo, name or other information may be placed, tongue 142 and button 140 provide positional stability to divot repair device 170 when the device is seated in body 112.

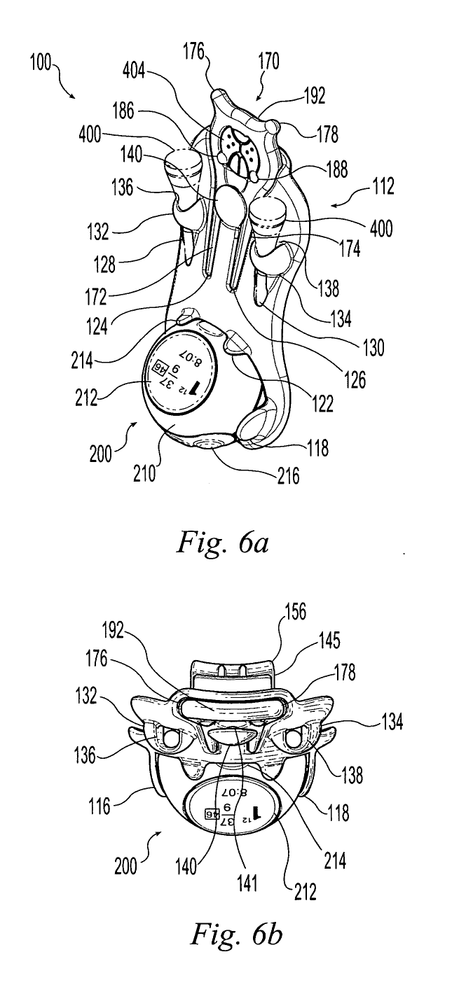

The top, rear edge of button 140 further includes a protruding knob 141 (see FIG. 6b) helps to secure the divot repair device when the device is inserted or snapped into body 112 (see arrow “B” in FIG. 3). As previously stated, body grooves 124 and 126 converge near the topmost portion of body 112 and form seat 144 that stabilizes the divot repair device within body 112 when the caddy device is properly assembled. Tab 146 is formed in seat 144 and forms the frontward facing portion of base 148 (see FIG. 5). Clip 150 may be inserted into base 148, which is formed on the rear portion or backside of body 112. Base 148 accepts the head 152 of clip 150 and engages clip groove 154 when the clip is properly attached to body 112.

With reference to FIGS. 3-4, on either side of body 112, between the outermost edge of the body and body grooves 124 and 126, first channel 128 and second channel 130 are formed. Viewing body 112 from the front, first channel 128 is located on the left-hand side of the body and includes a first protrusion 132 and a first aperture 136 for receiving tee 400 (see arrow “A” in FIG. 3). Likewise, second channel 130 is located on the right-hand side of the body and includes a second protrusion 134 and a second aperture 138 for receiving a second tee 400 (see arrow “A” in FIG. 3). First protrusion 132, second protrusion 134, first aperture 136 and second aperture 138 are shown in a top view of the caddy device in FIG. 6b. The exemplary embodiment of this invention is designed to accommodate at least one, and preferably two regular sized golf tees; however, in an alternate embodiment (not shown), one or both of the protrusions has been modified to accept a pencil or larger golf tee.

As best shown in FIGS. 3 and 5, belt clip 150 includes a head 152 that further includes a clip groove 154. When properly inserted into base 148, clip groove 154 engages a ridge (not shown), formed on the rear portion of tab 146, and when slight pressure is applied to arm 156, clip 150 snaps securely into place (see arrow “C” in FIG. 3). Clip 150 also includes arm 156 for providing tension to the clip and a plurality of ridges 160 for providing a gripping surface that increases friction between the clip and the surface to which the caddy device is mounted. When the clip is attached to the body of the caddy device, plurality of ridges 160 rests on clip support 135 and which is formed on the rear portion or back side of body 112. In alternate embodiments, other gripping or mounting devices such as clamps, clasps, and the like replace clip 150 and provide a means for attaching the caddy device to a belt or similar surface.

As best shown in FIG. 3, divot repair device 170 includes a first prong 172 and a second prong 174, both of which corresponded to a groove in body 112. The tapered ends of these prongs allow the device to be used for repairing divots or ball marks left on a putting green by a golf ball. Divot repair device 170 also includes a first horn 176 and a second horn 178 that together with lip 192 provide a surface for elevating the grip of a golf club off of the ground. By way of example, if the golfer carries two clubs to the putting green, such as a putter and a pitching wedge, divot repair device 170 may be used as a club prop to keep the grip of the pitching wedge off of the wet ground while the golfer putts out. This is accomplished by simply inserting the prongs of device 170 into the ground, laying the head of the club on the ground, and resting the club grip on lip 192. Horns 176 and 178 stabilize the club and prevent it from rolling off the tool and onto the wet ground.

As best shown in FIGS. 3 and 4, divot repair device 170 also serves as a convenient holder for a substantially circular item such as a coin (e.g., a dime) or plastic piece that may be used to mark a player's ball when putting on the green. In the exemplary embodiment, the area of divot repair device 170 above the prongs 172 and 174 is somewhat rounded in shape and includes a centrally placed, substantially circular bore or aperture 180 that passes partially through the material of divot repair device 170. As best shown in FIG. 4, the top portion of this aperture includes a support member 182 and the bottom portion of the aperture includes a first outer ridge 186 and a second outer ridge 188. The support member prevents golf ball marker 404 from passing completely through the aperture when inserted, and the outer ridges prevent the ball marker from falling out of the aperture after it has been installed. Installation is accomplished by simply placing the marker in the aperture and applying slight pressure to the marker until it snaps into place. The marker is removed from the aperture by pushing outward on the bottom portion of the marker until it is released. The marker itself may be a plastic disc that includes graphic images on its surface such as that shown in FIGS. 1 and 6a.

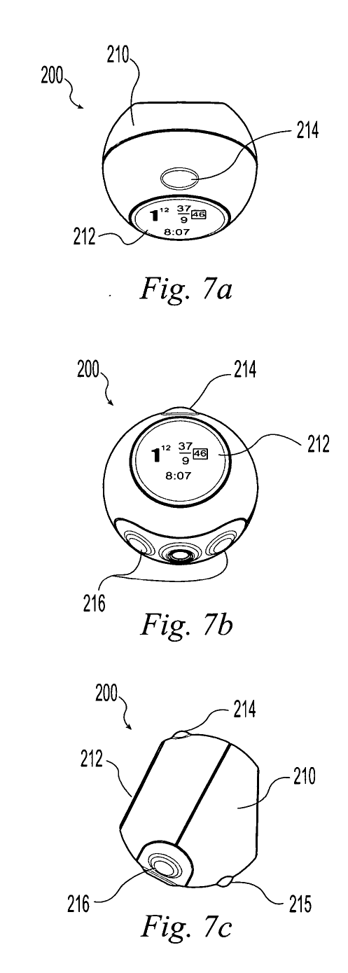

With reference to FIGS. 1-3, golf ball 402 may be snapped into cup 114, or alternately cup 114 may be used to hold stroke counting device 200. As shown in FIGS. 6a-7c, an exemplary embodiment of stroke counting device 200 includes a substantially spherical body 210 that is of roughly the same dimensions as a standard golf ball with the exception of the flattened, angled area of the body that comprises a visual display area 212 and the flattened rear portion of the device. In alternate embodiments, the flattened rear portion is replaced by a rounded portion. The stroke counting device is snapped into cup 114 in the same manner as a golf ball and is held in the proper orientation by top positioning knob 214 and bottom positioning knob 215. One or more switches 216 that are situated on the portion of the counter that typically faces the ground may be used to control the functions of the stroke counter. In the exemplary embodiment, when the stroke counting device is properly oriented in caddy device 100, the numbers appearing on the display area are upside-down relative to the body of the caddy device. This configuration allows the user of the device to easily view the display area while the caddy device is clipped to his or her belt (see FIGS. 6a and 6b).

In the exemplary embodiment, stroke counting device 200 comprises mechanical, electronic, digital, or a combination of mechanical, electronic, and digital means for recording the number of strokes the golfer has taken for each individual hole. The device may also be configured to calculate the total number of strokes taken for each round of nine holes and for each round of eighteen holes and to calculate a player's handicap based on previous rounds of golf. Other embodiments of the stroke counting device include a clock function and a compass function. As will be appreciated by those skilled in the art, the mechanical, electronic, and digital technology that is utilized by the stroke counting device is widely known and understood, is readily accessible, and may be easily configured to accomplish the various desired functions. The exterior of the stroke counter may be plastic, rubberized plastic, metal, or any other suitable durable material.

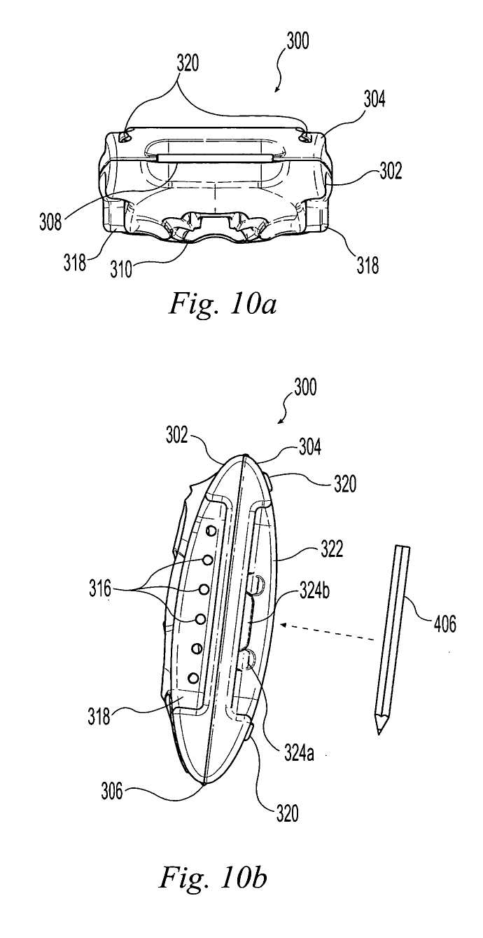

With reference now to FIGS. 1-2, 8a-8b, 9, and 10a-0b, multi-functional golf accessory 10 further includes a “docking station” or base 300 that includes additional storage features and functions. Base 300 includes a front portion 302 and a rear portion 304 that are joined together by an external hinge 306. In the exemplary embodiment, hinge 306 is a “living hinge;” however, other types of mechanical hinges may be used to join the front and rear portions.

Front portion 302 includes a transverse rod 308 that provides a means by which a strap may be attached to the accessory for the purpose of securing the accessory to a golf bag or other item. Front portion 302 also includes a port 310 that is specifically designed to receive the caddy device 100. The caddy device simply snaps into port 310 and is held there until removed by the user of the accessory. Front portion 302 also includes a first cup 312 and a second cup 314 that may be used in the same manner as cup 114 to store additional golf balls or a stroke counting device. In the exemplary embodiment, a plurality of apertures 316 is formed in a front inset region 318 that is located on either side of front portion 302. These apertures are useful for storing additional golf tees 400 in the accessory (see FIGS. 1 and 2).

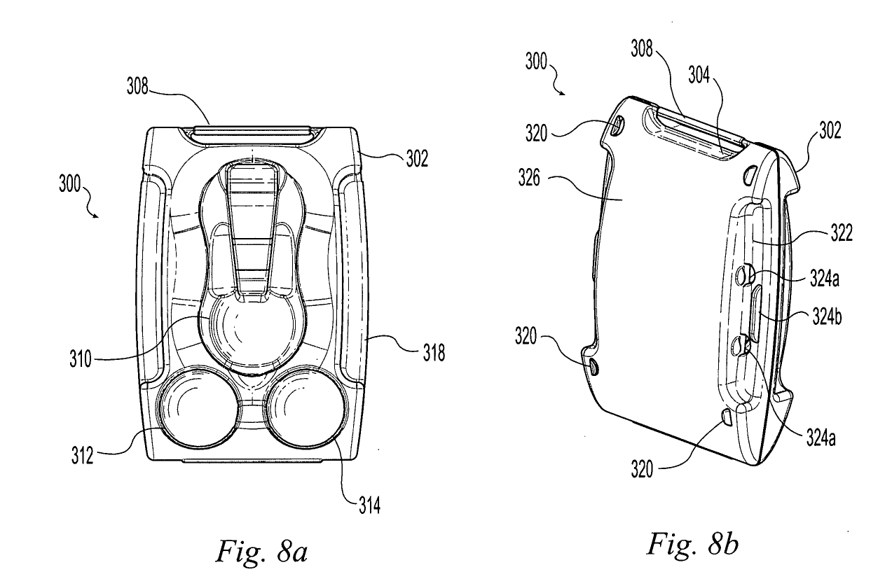

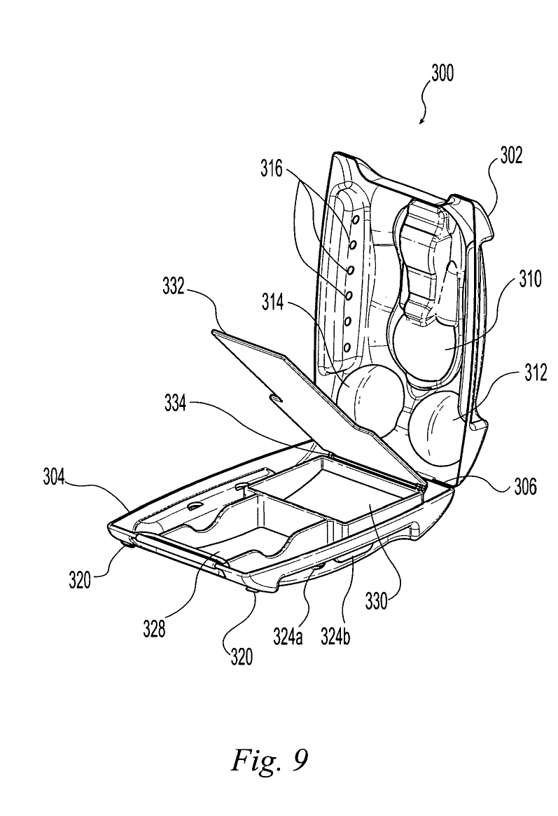

As best shown in FIG. 8b, rear portion 304 includes a plurality of card clips 320 formed on the exterior surface of the accessory. In the exemplary embodiment, these card clips are located near the perimeter of a relatively smooth writing surface 326 and serve as a means by which golf score card 408 may be secured against the writing surface. A rear inset region 322 is located on either side of the writing surface and includes a first pencil clip member 324a and a second pencil clip member 324b that cooperate to hold golf pencil 406 in place. As shown in FIG. 9, rear portion 304 further includes a first internal storage tray 328, useful for holding business cards, and a second storage tray 330, useful for holding other items such as, for example, cash or reference materials related to the game of golf. A closing panel 332 is attached by an internal hinge 334 to the bottom portion of tray 330 and serves to partition or close off the storage trays from the remaining space on the interior of the accessory.

The basic components of this invention may be manufactured from a variety of materials including, but not limited to, plastic, vinyl, polymer, metal, or combinations thereof using techniques that are widely known and used by those skilled in the manufacturing and fabricating arts. The work-piece components, i.e., the golf balls, tees, pencils, and score cards, are widely available from commercial sources.

While the above description contains many specificities, these should not be construed as limitations on the scope of the invention, but rather as exemplification of certain preferred embodiments. Numerous other variations of the present invention are possible, and is not intended herein to mention all of the possible equivalent forms or ramifications of this invention. Various changes may be made to the present invention without departing from the scope or spirit of the invention.

What is claimed:

1. A multi-functional golf accessory comprising:
(a) a base adapted to receive a detachable caddy device, and wherein said base further comprises external and internal storage means; and
(b) a caddy device adapted to be detachably mounted in said base, and wherein said caddy device further comprises a body adapted to receive a divot repair device, a detachable clip, at least one golf tee, and at least one of a golf ball and a stroke counting device.

2. The golf accessory of claim 1, further comprising a stroke counting device, and wherein said stroke counting device is adapted to be mountable within said caddy device.

3. The golf accessory of claim 2, wherein said stroke counting device is substantially spherical in shape and of substantially the same dimensions as a golf ball.

4. The golf accessory of claim 2, wherein said stroke counting device utilizes at least one of mechanical, electronic, and digital means for counting said strokes.

5. The golf accessory of claim 2, wherein said stroke counting device further comprises at least one of a clock, compass, and calculator.

6. The golf accessory of claim 1, wherein said base further comprises:
(a) a front portion, and wherein said front portion further comprises:
(i) at least one cup formed in said front portion for storing at least one of a golf ball and a stroke counting device;
(ii) a plurality of apertures formed in said front portion for storing at least one golf tee; and
(b) a rear portion joined to said front portion by hinge means, and wherein said rear portion further comprises:
(i) a substantially smooth exterior surface for providing a writing surface;
(ii) a first clip means for holding a score card on said writing surface;
(iii) a second clip means for holding a golf pencil; and
(iv) at least one storage compartment formed on the interior of said rear portion of said base.

7. The golf accessory of claim 1, wherein said base further comprises an attachment means for attaching said base to a golf bag or the like.

8. The golf accessory of claim 1, wherein said caddy device further includes a stencil for marking a golf ball or the like.

9. The golf accessory of claim 1, wherein said divot repair device further includes a top region and a bottom region, and wherein said top region further comprises an aperture passing partially though the material of said top region, and wherein said aperture is adapted to receive a removable golf ball marker.

10. A multi-functional accessory for golfers, comprising a caddy device adapted to be detachably mountable in a separate base, and wherein said caddy device further comprises a body adapted to receive a divot repair device, a detachable belt clip, at least one golf tee, and at least one of a golf ball and a stroke counting device.

11. The golf accessory of claim 10, further comprising a stroke counting device, and wherein said stroke counting device is adapted to be mountable within said caddy device.

12. The golf accessory of claim 11, wherein said outer surface of said stroke counting device is substantially spherical in shape and of substantially the same dimensions as a golf ball.

13. The golf accessory of claim 11 wherein said stroke counting device utilizes at least one of mechanical, electronic, and digital means for counting said strokes.

14. The golf accessory of claim 11, wherein said stroke counting device further comprises at least one of a clock, compass, and calculator.

15. The golf accessory of claim 11, wherein said stroke counting device further comprises at least one positioning knob for properly orienting said stroke counting device within said caddy device.

16. The golf accessory of claim 11, wherein said stroke counting device further comprises a visual display area, and wherein said display area is oriented to be clearly readable from above when said stroke counting device is mounted within said caddy device and said caddy device is clipped to the belt of a golfer.

17. The golf accessory of claim 10, wherein said caddy device further includes a stencil for marking a golf ball or the like.

18. The golf accessory of claim 10, wherein said divot repair device further includes a top region and a bottom region, and wherein said top region further comprises an aperture passing partially though the material of said top region and wherein said aperture is adapted to receive a removable golf ball marker.

19. The golf accessory of claim 18, wherein said ball marker is a coin, and wherein said coin is a dime.

20. A multi-functional accessory for golfers, comprising a stroke counting device adapted to be mountable in a separate caddy device, and wherein said stroke counting device further comprises a visual display area, and wherein said stroke counting device is substantially spherical in shape and of substantially the same dimensions as a golf ball and utilizes at least one of mechanical, electronic, and digital means for counting said strokes.
